(19) United States
(12) Patent Application Publication
(10) Pub. No.: US 2003/0201378 A1
(43) Pub. Date: Oct. 30, 2003

(54) Operating microscope

(75) Inventors: Tomonori Ishikawa, Tokyo (JP); Shunichiro Takahashi, Tokyo (JP)

Correspondence Address: SCULLY SCOTT MURPHY & PRESSER, PC, 400 GARDEN CITY PLAZA, GARDEN CITY, NY, 11530

(73) Assignee: OLYMPUS OPTICAL CO., LTD., TOKYO (JP)

(21) Appl. No.: 10/375,490

(22) Filed: Feb. 27, 2003

(30) Foreign Application Priority Data
Apr. 24, 2002 (JP) 2002-122972

(51) Int. Cl. G02B 7/04

(52) U.S. Cl. 250/201.3

(57) ABSTRACT

An operating microscope is disclosed which has a variable magnification observing optical system capable of varying according to an observing magnification the exit position of illuminating light to be irradiated onto an observation target. For example, during low-magnification observation using a wide observing light flux, illuminating light is made to exit toward the observation target from a position distant from an observing optical axis, whereas during high-magnification observation using a narrow observing light flux, illuminating light is made to exit toward the observation target from a position close to the observing optical axis. Accordingly, the observation target can be illuminated from a direction as close as possible to the observing optical axis without allowing a member for illumination to interfere with an observing light flux.

### CROSS-REFERENCE TO RELATED APPLICATION

This application is based upon and claims the benefit of priority from the prior Japanese Patent Application No. 2002-122972, filed Apr. 24, 2002, the entire contents of which is incorporated herein by reference.

### BACKGROUND OF THE INVENTION

1. Field of the Invention

The present invention relates to an operating microscope having observing magnification capable of being varied.

2. Description of the Related Art

In recent years, to meet demands for smaller invasions during operations, operations using operating microscopes to enable fine treatments have been widely performed. In general, operating microscopes contain an optical system having the function of varying its observing magnification. For example, in neurosurgical operations, such an operating microscope makes it possible to perform, through observation at optimum magnification, various treatments such as removal of a tumor, a malformation progress preventing treatment for a blood vessel exhibiting a malformation, the anastomosis of a blood vessel.

Areas to be operated on are not only plane surface areas, but are also situated in greatly deepened portions. Accordingly, particularly in the case where an area to be operated on is in a deeply formed hole, illuminating light for illuminating the area is easily obstructed by the entrance of the hole. For this reason, in order that a more sufficient amount of illuminating light can reach a deep portion of the hole, it is preferable to make the optical axis of illuminating light closer to the optical axis of observing light for observing the area.

From this fact, various proposals have heretofore been made with respect to the art of disposing the optical axis of illuminating light for illuminating an area to be operated on (hereinafter referred to as the illuminating optical axis) at a position closer to the optical axis of observing light for observing the area (hereinafter referred to as the observing optical axis), or the art of disposing the observing optical axis and the illuminating optical axis in a mutually coincident manner.

For example, the operating microscope of JP-A-8-257037 is constructed so that a semi-transparent and semi-reflecting member is disposed immediately below an observing optical system (on the optical axis thereof) and an illuminating light flux is made incident on the semi-transparent and semi-reflecting member from a direction perpendicular to the optical axis of the observing optical system. In this manner, the observing optical axis and the illuminating optical axis are made coincident with each other, and illuminating light is irradiated onto an area to be operated on, from a direction in which the illuminating optical axis completely coincides with the observing optical axis.

In the operating microscopes of Japanese. Pat. No. 3,011,950 and of JP-A-10-73769, the irradiation axis of illuminating light to be emitted from a light source contained in an operating microscope is separated into two irradiation axes so that in the case where an area to be operated on is situated in a deep hole, the interior of the deep hole can be irradiated with a large amount of illuminating light. The respective irradiation axes of illuminating light are fixedly disposed at the right and left positions symmetrical with respect to the observing optical axis, and each illuminating light is irradiated onto an observation target from two predetermined directions.

The operating microscopes of JP-P-6-44101 and of Japanese Pat. No. 2,891,923 have an illuminating optical system constructed to guide an illuminating light flux to an area to be operated on, from a location positioned above an object opposing surface of an objective lens, through an intermediate space between a pair of right and left observing light fluxes corresponding to the right and left eyes of an observer. The area is illuminated through the space between the pair of right and left observing light fluxes by the illuminating optical system.

### BRIEF SUMMARY OF THE INVENTION

An operating microscope according to the invention includes an observing optical system for observing an observation target, the observing optical system having an observing magnification capable of being varied, and an illuminating optical system for irradiating illuminating light onto the observation target from an outside of the observing optical system, an exit position of the illuminating light is capable of being varied. Accordingly, even in the case where the diameter of an observing light flux is varied with a variation of the observing magnification, the exit position of illuminating light can be varied so that the illuminating light flux does not interfere with the observing light flux and so that illuminating light is irradiated onto the observation target from an angle close to the optical axis of the observing light flux. Accordingly, even if the observation target has a deep concave portion, illuminating light may be easily irradiated onto the bottom of the concave portion. In addition, since the illuminating light is irradiated onto the observation target without passing through an objective lens of the observing optical system, the occurrence of flares can be restrained.

The operating microscope preferably has a system for interlocking a variation of the observing magnification of the observing optical system with a variation of the exit position of the illuminating light of the illuminating optical system. According to this construction, a variation of the observing magnification and a variation of the exit position of the illuminating light are interlocked with each other, whereby it is possible to omit the process of adjusting both the observing magnification and the exit position. In addition, it is preferable that a variation of the irradiation position of illuminating light be accompanied by a variation of the irradiation angle of illuminating light. According to this construction, the optical axis of illuminating light can be consistently made to pass through the observation target, whereby good illumination conditions can be realized.

In many cases, the width of the observing light flux is large at the time of low-magnification observation, and at the time of high-magnification observation, the width of the observing light flux is narrow. Accordingly, in the operating microscope according to the invention, it is desirable that the exit position of illuminating light be situated at a position distant from the observing optical axis at the time of low-magnification observation and, at the time of high-magnification observation, the exit position of illuminating light is situated at a position close to the observing optical axis.

In the case of an operating microscope for stereoscopic view, a pair of right and left observing light flux are used. In this case, at the time of high-magnification observation, since the width of each of the observing light flux is narrow, the space between the right and left observing light fluxes is widely opened. It is preferable to place the exit position of illuminating light in the space at the time of high-magnification observation, since illuminating light can be irradiated from a direction extremely close to the observing optical axis.

Various mechanisms can be adopted as a mechanism for varying the exit position and the exit angle of illuminating light. For example, there is a method of providing a turnable reflecting member (a mirror or a prism) in the illuminating optical system and varying the angle and the position of the turnable reflecting member. Examples of a mechanism which varies the position of an optical element such as the reflecting member are a rack and pinion mechanism and a ball thread. An example of a mechanism which varies the angle of the optical element mechanism is a mechanism using a gear or the like. In addition, it is efficient to realize the variations of the position and the angle of the optical element by using one motor. In addition, the exit position and angle of illuminating light may also be varied without using a motor, through a mechanical link to the movement of a frame member which supports a variable magnification optical system.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is an explanatory side view showing the state in which an observation target is observed at low magnification in an operating microscope according to a first embodiment of the invention;

FIG. 2 is an explanatory side view showing the state in which the observation target is observed at high magnification in the operating microscope according to the first embodiment of the invention;

FIG. 3 is an explanatory side view showing the state in which the observation target is observed at low magnification in an operating microscope according to a second embodiment of the invention;

FIG. 4 is a plan view of a part of the operating microscope according to the second embodiment of the invention;

FIG. 5 is a block diagram showing a control system of the operating microscope according to the second embodiment of the invention;

FIG. 6 is an explanatory view of an observing optical system, showing the state,in which the observation target is observed at high magnification in the operating microscope according to the second embodiment of the invention;

FIG. 7 is an explanatory side view showing the state in which the observation target is observed at low magnification in an operating microscope according to a third embodiment of the invention;

FIG. 8 is an explanatory side view showing the state in which the observation target is observed at high magnification in the operating microscope according to the third embodiment of the invention;

FIG. 9A is an explanatory side view showing optical systems of an operating microscope according to a fourth embodiment of the invention;

FIG. 9B is an explanatory view showing relevant portions seen from below, aiding in explaining the positional relationship between observing light fluxes and a portion through which illuminating light exits, in the operating microscope according to the fourth embodiment of the invention;

FIG. 10A is an explanatory side view showing optical systems (for low-magnification observation) of an operating microscope according to a fifth embodiment of the invention;

FIG. 10B is an explanatory view showing relevant portions seen from below, aiding in explaining the positional relationship between observing light fluxes and a portion through which illuminating light exits, at the time of low-magnification observation in the operating microscope according to the fifth embodiment of the invention;

FIG. 11A is an explanatory side view showing optical systems (for high-magnification observation) of the operating microscope according to the fifth embodiment of the invention; and

FIG. 11B is an explanatory view showing the relevant portions seen from below, aiding in explaining the positional relationship between observing light fluxes and a portion through which illuminating light exits, at the time of high-magnification observation in the operating microscope according to the fifth embodiment of the invention.

### DETAILED DESCRIPTION OF THE INVENTION

Preferred embodiments of the invention will be described below with reference to the accompanying drawings.

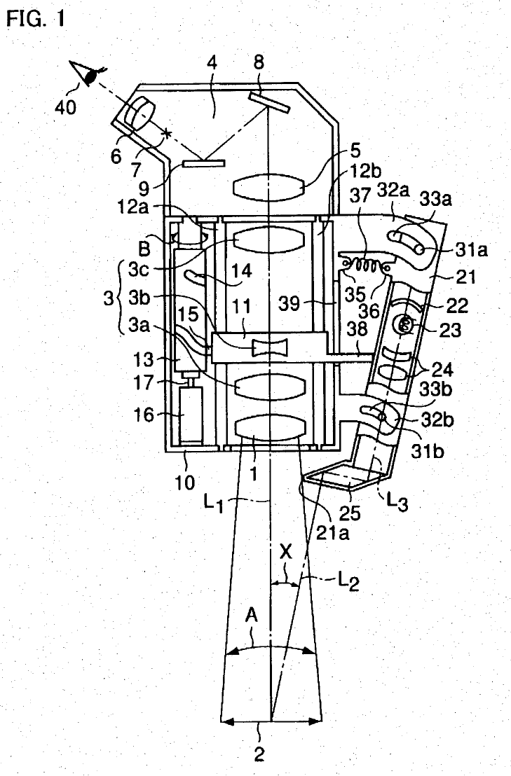

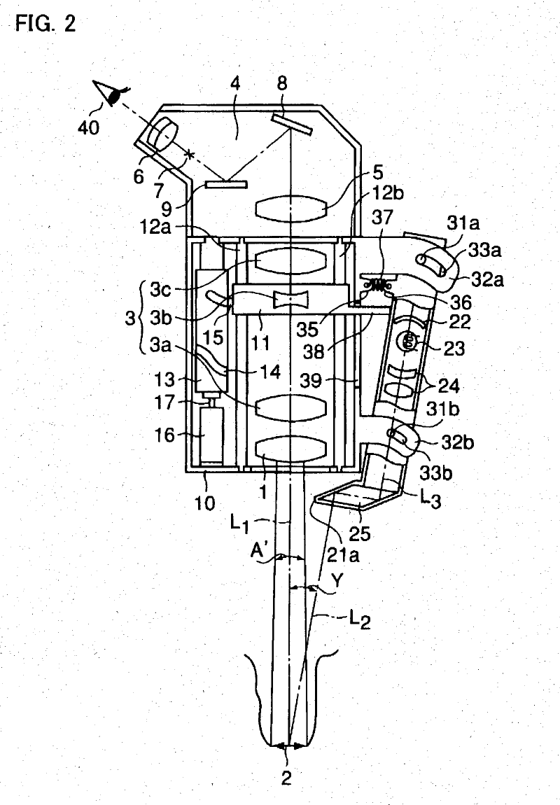

An operating microscope according to a first embodiment of the invention will be described below with reference to FIGS. 1 and 2. FIGS. 1 and 2 show a schematic construction of the operating microscope which is viewed from one side thereof. FIG. 1 shows the state in which an observation target is observed at low magnification, while FIG. 2 shows the state in which the observation target is observed at high magnification.

In the observing part of a stereomicroscope such as the operating microscope, its optical system usually includes an objective lens and the following optical systems have a pair of right and left observing optical systems to give a parallax corresponding to the right and left eyes of an observer. Since FIGS. 1 and 2 are views showing the operating microscope viewed from one side thereof, only one of the pair of right and left observing optical systems is illustrated in each of FIGS. 1 and 2. The other of the pair of right and left observing optical systems is substantially similar to that shown in FIGS. 1 and 2.

As shown in FIGS. 1 and 2, an objective lens 1 of the observing optical system (observing means) is positioned above an observation target (for example, an area to be operated on) 2 with a focus position lying on the observation target 2. The objective lens 1 causes a light flux incident thereon to exit toward a variable magnification lens system 3 as an afocal light flux. As shown in FIGS. 1 and 2, as the operating microscope is viewed from one side thereof, a pair of right and left optical axes (observing optical axes L1) of the objective lens 1 and the respective variable magnification lens systems 3 are seen to be superposed in the form of one straight line.

The case where the observation target 2 is observed at low magnification (FIG. 1) and the case where the observation target 2 is observed at high magnification (FIG. 2) differ in the angle of view of the light flux between the objective lens 1 and the observation target 2. The angle of view at which the observation target 2 is observed at low magnification as shown FIG. 1 is A, while the angle of view at which the observation target 2 is observed at high magnification as shown FIG. 2 is A′. In general, in the operating microscope, since the position of each pupil of the observer is distant from the objective lens 1, the angle of view A of the light flux through which the observation target 2 is observed at low magnification is wider than the angle of view A′ of the light flux through which the observation target 2 is observed at high magnification.

The variable magnification lens system 3 of the observing optical system performs afocal magnification variation on the light flux incident from the objective lens 1, and causes the resultant afocal light flux to exit toward an ocular optical system 4.

The ocular optical system 4 includes an image-forming lens 5 and an ocular lens 6. The image-forming lens 5 is disposed on the optical axis L1, and the afocal light flux exiting from the variable magnification lens system 3 is made incident on the image-forming lens 5. A light flux exiting from the image-forming lens 5 forms an image on an image-forming position 7 through a reflecting member 8 and a reflecting member 9. The ocular lens 6 magnifies the image formed on the image-forming position 7 and allows an operator 40 to observe the magnified image.

The variable magnification lens system 3 includes three lenses 3a, 3b and 3c. The lenses 3a and 3c which are respectively positioned on opposite extreme sides are fixed to a lens barrel housing 10 by a stationary lens frame (not shown), while the lens 3b positioned in the middle is fixed to a movable lens frame 11 which is movable along the observing optical axis L1. The movable lens frame 11 is guided to move along the observing optical axis L1 by guide shafts 12a and 12b. Inserting holes (not shown) through which the respective guide shafts 12a and 12b are inserted are provided in the movable lens frame 11. The guide shafts 12a and 12b are respectively disposed on the right and left sides of the observing optical axis L1 in the lens barrel housing 10, and are disposed to extend in parallel with the observing optical axis L1. The opposite ends of each of the guide shafts 12a and 12b are supported by the lens barrel housing 10.

A cam cylinder 13 which is adjacent to the guide shaft 12a and has its central axis of rotation arranged in parallel with the guide shaft 12a is disposed in the lens barrel housing 10. The cam cylinder 13 is supported by the lens barrel housing 10 in such a manner as to be rotatable in opposite directions indicated by an arrow B in FIG. 1. A cam groove 14 is formed on the outer circumference of the cam cylinder 13, and a follower pin 15 one end of which is fixedly embedded in the movable lens frame 11 is engaged with the cam groove 14 with the other protruding end fitted therein. The cam cylinder 13 is rotationally driven by a motor 16 which is controlled by an external input. The motor 16 has an output shaft 17 disposed coaxially with the cam cylinder 13, and the output shaft 17 is coaxially connected to the cam cylinder 13. The body of the motor 16 is fixed to the lens barrel housing 10.

An approximately cylindrical illuminating housing 21 which houses an illuminating light source 23 and an illuminating optical system to be described later is secured to the front surface of the lens barrel housing 10 at a variable inclination angle. An illuminating light source 23 provided with a reflecting mirror 22, a condenser lens 24, a reflecting member 25 (for example, a prism or a mirror) and the like are provided in the illuminating housing 21. The reflecting member 25 is provided for turning the exiting direction of illuminating light emitted from the illuminating light source 23, toward the observation target 2.

As shown in FIGS. 1 and 2, an optical axis (illuminating optical axis) L2 of an illuminating light flux exiting from the reflecting member 25 toward the observation target 2 is positioned to be displaced toward the lens barrel housing 10 as compared with an optical axis L3 of an optical system including the reflecting mirror 22, the illuminating light source 23 and the condenser lens 24 all of which are disposed in the illuminating housing 21. Part of this illuminating optical system (at least an exit surface of the reflecting member 25 from which illuminating light exits toward the observation target 2) is disposed in the space between the objective lens 1 and the observation target 2. In the illuminating optical system, illuminating light is introduced from one side of the space between the objective lens 1 and the observation target 2, and is irradiated onto the observation target 2 by the reflecting member 25.

An end portion 21a of the illuminating housing 21 in which the reflecting member 25 is incorporated is protruded in the direction of the lens barrel housing 10 compared to the other portion of the illuminating housing 21. Accordingly, the end portion 21a is protruded toward the observing optical axis L1 in the space between the objective lens 1 and the observation target 2. The optical axes L2 and L3 related to the illuminating optical system are substantially parallel to each other.

The following description will be given in connection with an illuminating light irradiation angle varying mechanism which varies the inclination angle of the illuminating housing 21 to vary an illuminating angle X, thereby varying the relative position between the observing optical axis L1 of the objective lens 1 and a position to be irradiated with illuminating light.

Follower pins 31a and 31b are respectively provided on the top and bottom sides of the illuminating housing 21. The follower pins 31a and 31b are respectively fitted in slots 33a and 33b which are respectively formed in wing-shaped portions 32a and 32b protruded from the lens barrel housing 10. Each of the slots 33a and 33b formed in the respective wing-shaped portions 32a and 32b is formed in the shape of a circular arc centered at a point on the observation target 2. The respective follower pins 31a and 31b are slidably fitted in the corresponding slots 33a and 33b, whereby the illuminating housing 21 is supported by the lens barrel housing 10 and, at the same time, is capable of performing tilting movement centered at the position of the observation target 2.

Spring hooking portions 35 and 36 are respectively disposed on the lens barrel housing 10 and the illuminating housing 21 in opposition to each other. A tension spring 37 is passed between the spring hooking portions 35 and 36 to bias the illuminating housing 21 towards the lens barrel housing 10. Specifically, one end of the tension spring 37 is hooked on the spring hooking portion 35 of the lens barrel housing 10, while the other end of the tension spring 37 is hooked on spring hooking portion 36 of the illuminating housing 21. Thus, the tension spring 37 constantly tensely pulls the illuminating housing 21 toward the lens barrel housing 10.

A restricting protruding portion 38 is integrally formed on the movable lens frame 11 of the variable magnification lens system 3, and is protruded toward the illuminating housing 21. The restricting protruding portion 38 passes through a window 39 opened in a side wall of the lens barrel housing 10 and is exposed to the outside of the lens barrel housing 10, and the protruding end of the restricting protruding portion 38 is brought into abutment with a side surface of the illuminating housing 21. The restricting protruding portion 38, which is fixed in length, serves to tilt the illuminating housing 21 to an adequate extent by moving up or down together with the movable lens frame 11.

The length of the restricting protruding portion 38 is set to a length which constantly restricts the end portion 21a of the illuminating housing 21 to a position as close to an observing light flux as possible within the range where the end portion 21a does not overlap an observing light flux of width equal to the angle of view A through which the observation target 2 is observed at low magnification nor an observing light flux of width equal to the angle of view A′ through which the observation target 2 is observed at high magnification. Namely, when the operating microscope is in the state shown in FIG. 1 where the observation target 2 is observed at low magnification, the movable lens frame 11 is moved down to change the amount of protrusion of the illuminating housing 21 so that the end portion 21a of the illuminating housing 21 is made as close as possible to the area of the observing light flux having the angle of view A without overlapping the area of the observing light flux. On the other hand, when the operating microscope is in the state shown in FIG. 2 where the observation target 2 is observed at high magnification, the end portion 21a of the illuminating housing 21 is made as close as possible to the area of the observing light flux having the angle of view A′ without overlapping the area of the observing light flux.

The function of the operating microscope according to the first embodiment will be described below. Light emitted from the illuminating light source 23 illuminates the observation target 2 obliquely from one side of the observing optical axis L1 between the objective lens 1 and the observation target 2 through the condenser lens 24 and the reflecting member 25. Illuminating light reflected at the observation target 2 enters the objective lens 1, and then passes through the variable magnification lens system 3 and the image-forming lens 5, whereby the operator 40 observes a magnified image through the ocular lens 6.

During the state of low-magnification observation shown in FIG. 1, the angle X formed by the observing optical axis L1 and the illuminating optical axis L2 is comparatively large according to the width of the angle of view A of the observing light flux. When this state is to be changed into the state of high-magnification observation, the motor 16 is activated by an external input. Then, the cam cylinder 13 connected to the motor 16 is rotated. When the cam cylinder 13 is rotated, the movable lens frame 11 fitted on the guide shafts 12a and 12b is moved upward along the observing optical axis L1 by means of the follower pin 15 engaged with the cam groove 14. Thus, the movable lens frame 11 is positioned at the top position shown in FIG. 2. According to the movement of the movable lens frame 11, the restricting protruding portion 38 integral with the movable lens frame 11 is displaced, and the illuminating housing 21 placed in abutment with the restricting protruding portion 38 is also tilted and displaced.

The tilting and displacing movement of the illuminating housing 21 is performed as follows. First, the restricting protruding portion 38 is moved upward in parallel with the observing optical axis L1. Accordingly, if the illuminating housing 21 is not pulled by the tension spring 37, the restricting protruding portion 38 will come off the side surface of the illuminating housing 21 disposed obliquely with respect to the observing optical axis L1. However, since the illuminating housing 21 is pulled toward the lens barrel housing 10 by the tension spring 37, the illuminating housing 21 tends to be constantly displaced in contact with the protruding end of the restricting protruding portion 38. At this time, since the respective follower pins 31a and 31b are engaged with the slots 33a and 33b each having the above-described circular arc, the respective follower pins 31a and 31b follow the circular arcs of the slots 33a and 33b that are formed to be centered at the position of the observation target 2. Accordingly, the illuminating housing 21 is tilted so that the illuminating optical axis L2 constantly passes through the center of the observation target 2.

In this manner, the illuminating housing 21 is displaced from the state of FIG. 1 to the state of FIG. 2. Then, the angle formed by the illuminating optical axis L2 and the observing optical axis L1 becomes small. This angle is denoted by symbol Y in FIG. 2. In this case, the most protruding end portion 21a that is a part of the illuminating housing 21 becomes closer to the observing optical axis L1. However, as shown in FIG. 2, the angle of view A′ of the observing light flux corresponding to the state of high-magnification observation is small relative to the angle of view A′ of the observing light flux corresponding to the state of low-magnification observation shown in FIG. 1, so that the end portion 21a does not interfere with the observing light flux nor hinder observation. Accordingly, the operator 40 can clearly observe the observation target 2 at high magnification.

As described above, according to the illuminating light irradiation angle varying mechanism of the first embodiment, the angle of the illuminating optical axis L2 to the observing optical axis L1 becomes smaller in interlocking relationship to the manipulation of the operator 40 to vary observing magnification from lower magnification to higher magnification, whereby the illuminating optical axis L2 becomes closer to the observing optical axis L1. Accordingly, even when the operator 40 is to observe the interior of an area to be operated on, such as a deep hole which often needs to be observed at high magnification, the operator 40 may observe the area of the observation target 2 illuminated with a sufficient amount of illuminating light. In addition, during observation at any magnification, the members of the illuminating optical system are retracted to a position where the members do not interfere with the observing light flux, whereby the members do not at all hinder observation. Furthermore, since a part of the illuminating optical system (at least an exit position of illuminating light directed to the observation target 2) is disposed in the space between the objective lens 1 and the observation target 2, the illuminating light flux is directed to the observation target 2 by the reflecting member 25 disposed below the objective lens 1, and does not pass through the objective lens 1. Accordingly, an adverse influence such as flare on the observing optical system due to the surface reflection of the objective lens 1 does not occur.

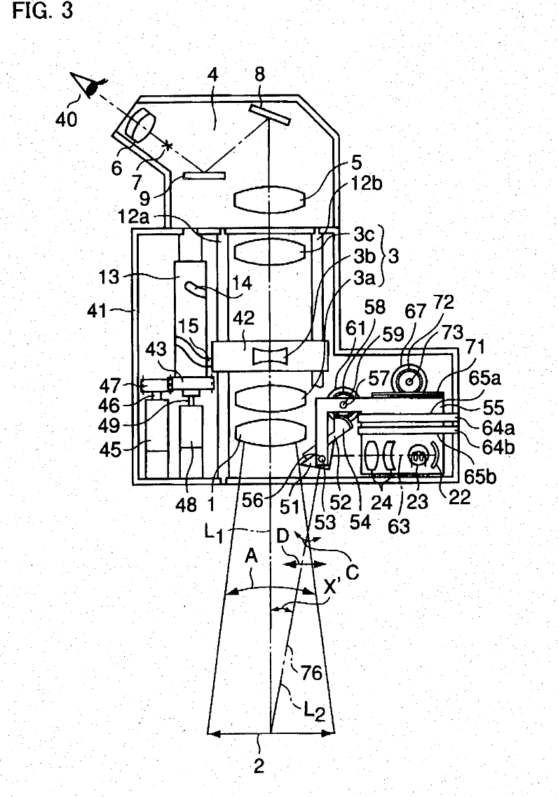

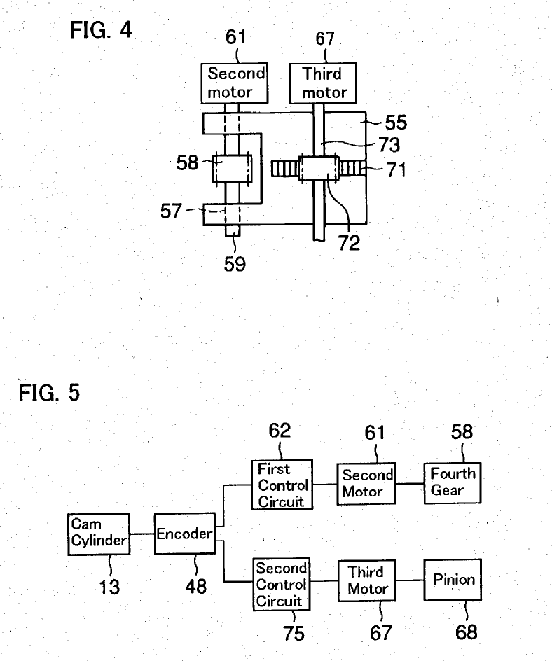

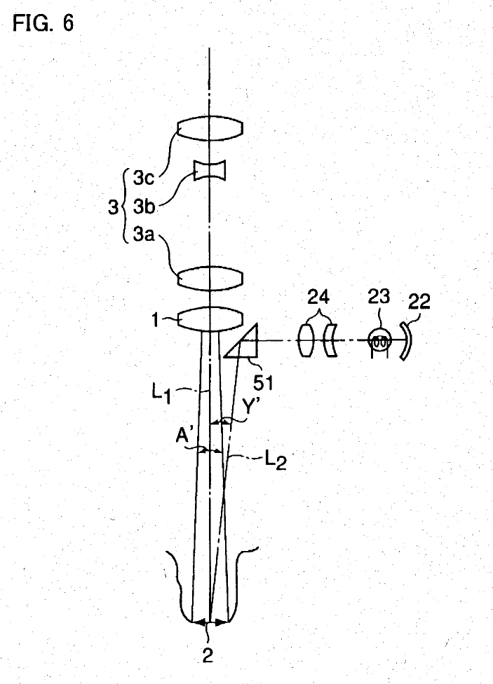

An operating microscope according to a second embodiment of the invention will be described below with reference to FIGS. 3 to 6. FIG. 3 is a view of the operating microscope viewed from one side thereof, which is set to the state of enabling an observation target to be observed at low magnification. FIG. 4 is a view seen from above, of a mechanism portion which varies the irradiation position and the irradiation angle of the illuminating light shown in FIG. 3. FIG. 5 is a block diagram showing a control system of the second embodiment. FIG. 6 is an explanatory view of an observing optical system which is set to the state of enabling an observation target to be observed at high magnification. In the description of the second embodiment, constituent parts and portions common to those of the first embodiment are denoted by the same reference numerals as those used in the above description, and the description of the same parts and portions is omitted.

In the second embodiment, a lens barrel housing 41 contains both an observing optical system and an illuminating optical system. A lens frame 42 which supports the lens 3b of the variable magnification lens system 3 differs from the above-described movable lens frame 11 of the first embodiment in that the lens frame 42 does not have the restricting protruding portion 38. The cam cylinder 13 has a first gear 43 at one end portion. The first gear 43 is engaged with a second gear 47 fixed to an output shaft 46 of a first motor 45. The first motor 45 is controlled by an external input, and the first motor 45 is driven to rotate the cam cylinder 13 through the second gear 47 and the first gear 43. An input shaft 49 of an encoder 48 is connected to one end of the cam cylinder 13, and the rotation angle of the cam cylinder 13 is detected by the encoder 48.

The illuminating optical system is capable of irradiating illuminating light onto an observation target, and the exit position of illuminating light is disposed in the space between the objective lens 1 and the observation target 2. The illuminating optical system is provided with a reflecting member 51 made of a prism for deflecting illuminating light exiting from the condenser lens 24 toward the observation target 2, where the reflecting member 51 is supported on a prism frame 52. The reflecting member 51 is positioned near the objective lens 1 at a location lower than the objective lens 1, and is disposed in the space between the objective lens 1 and the observation target 2.

The prism frame 52 has a rotating shaft 53 which extends in a direction perpendicular to the surface of the sheet of FIG. 3, and a third gear 54 is formed at a turning end portion of the prism frame 52. A fitting hole 56 into which the rotating shaft 53 of the prism frame 52 is fitted are provided in an, illuminating housing 55 which contains the illuminating optical system. A fitting hole 57 different from the fitting hole 56 is provided in the illuminating housing 55, and a rotating shaft 59 of a fourth gear 58 is fitted in the fitting hole 57. The fourth gear 58 is disposed in engaging relationship with the third gear 54, and an output shaft of a second motor 61 which is disposed on the same axis as the central axis of the rotating shaft 59 of the fourth gear 58 is connected to the rotating shaft 59. The second motor 61 is controlled to a rotation angle according to a count value of the encoder. 48 by A first control circuit 62 (refer to FIG. 5).

The lens barrel housing 41 is provided with two guide shafts 64a and 64b which are supported to be disposed in parallel with an illuminating optical axis 63. The respective guide shafts 64a and 64b are slidably fitted in fitting holes 65a and 65b which are formed in the illuminating housing 55 to extend in parallel with the illuminating optical axis 63. Accordingly, the entire illuminating housing 55 is slidable back and forth along the guide shafts 64a and 64b in the direction of the illuminating optical axis 63.

A rack 71 is provided on an external surface of the illuminating housing 55, and the rack 71 is engaged with a pinion 72 disposed in the lens barrel housing 41. A rotating shaft 73 of the pinion 72 is connected to an output shaft of a third motor 67. The rotation angle of the third motor 67 is controlled by a second control circuit 75 (refer to FIG. 5) according to the count value of the encoder 48. These constituent elements constitute a varying mechanism which moves the illuminating optical system to vary the relative position between the optical axis of the objective lens 1 and the illuminating optical system.

The function of the illuminating light irradiation angle varying mechanism of the second embodiment will be described below. When the first motor 45 is activated by an external input, the second gear 47 fixed to the output shaft 46 of the first motor 45 is rotated. The rotation of the second gear 47 is transmitted to the first gear 43, whereby the cam cylinder 13 is rotated. As shown in FIG. 5 which is a block diagram of an information transmission path, when the cam cylinder 13 is rotated, the lens frame 42 which supports the lens 3b of the variable magnification lens system 3 is moved, whereby the variation of observing magnification is performed. At this time, the angle through which the cam cylinder 13 is rotated is detected by the encoder 48, and the obtained information is transmitted to both the first control circuit 62 and the second control circuit 75. The first control circuit 62 and the second control circuit 75 respectively perform predetermined calculations on the basis of the information sent from the encoder 48, and respectively rotate the second motor 61 and the third motor 67 by angles based on the obtained calculation results.

When the second motor 61 is rotated, the fourth gear 58 is rotated, and the rotation of the fourth gear 58 is transmitted to the third gear 54. Accordingly, since the prism frame 52 is rotated about the rotating shaft 53, the reflecting member 51 supported on the prism frame 52 is also rotated at the same time. Therefore, the angle of illuminating light 76 exiting from the reflecting member 51 is varied in the direction of an arrow C of FIG. 3.

When the third motor 67 is rotated, the pinion 72 engaged with the rack 71 of the illuminating housing 55 is rotated, whereby the illuminating housing 55 is moved in a horizontal direction along the guide shafts 64a and 64b. In addition, since the reflecting member 51 is supported on the illuminating housing 55 by means of the prism frame 52, the reflecting member 51 moves together with the illuminating housing 55. Accordingly, as shown in FIG. 3, the direction of the illuminating light 76 exiting from the reflecting member 51 is varied to either one of the directions indicated by an arrow. D.

As described above, the relative position between the illuminating optical system and the optical axis of the objective lens 1 is varied by the rotation of each of the second motor 61 and the third motor 67, and at the same time, the illuminating optical axis L2 achieves rotation and horizontal movement. At this time, the first control circuit 62 and the second control circuit 75 respectively control the rotation angles of the second motor 61 and the third motor 67 so that the illuminating optical axis L2 is constantly directed to the observation target 2 in whatever state the operating microscope may be. Accordingly, the angle X′ illustrated in FIG. 3 showing the state of low-magnification observation, which is formed by the observing optical axis L1 and the illuminating optical axis L2 becomes an angle Y′ during the state of high-magnification observation shown in FIG. 6. The angle Y′ is smaller compared to the angle X′.

As described above, according to the illuminating light irradiation angle varying mechanism of the second embodiment, the angle of the illuminating optical axis L2 to the observing optical axis L1 becomes closer in interlocking relationship to the manipulation of the operator 40 to vary observing magnification from lower magnification to higher magnification, similarly to the case of the first embodiment. Accordingly, even when the operator 40 is to observe an area to be operated on within a deep hole which often needs to be observed at high magnification, the operator 40 may observe the area of the observation target 2 illuminated with a sufficient amount of illuminating light. In addition, during observation at low magnification, the members of the illuminating optical system do not at all interfere with the passage of an observing light flux. Furthermore, the illuminating light flux is directed to the observation target 2 by the reflecting member 51 of the illuminating optical system disposed below the objective lens 1 and does not pass through the objective lens 1. Accordingly, an adverse influence such as flare on the observing optical system due to the surface reflection of the objective lens 1 does not occur. Since the illuminating housing 55 is contained in the lens barrel housing 41, the entire operating microscope can be made compact.

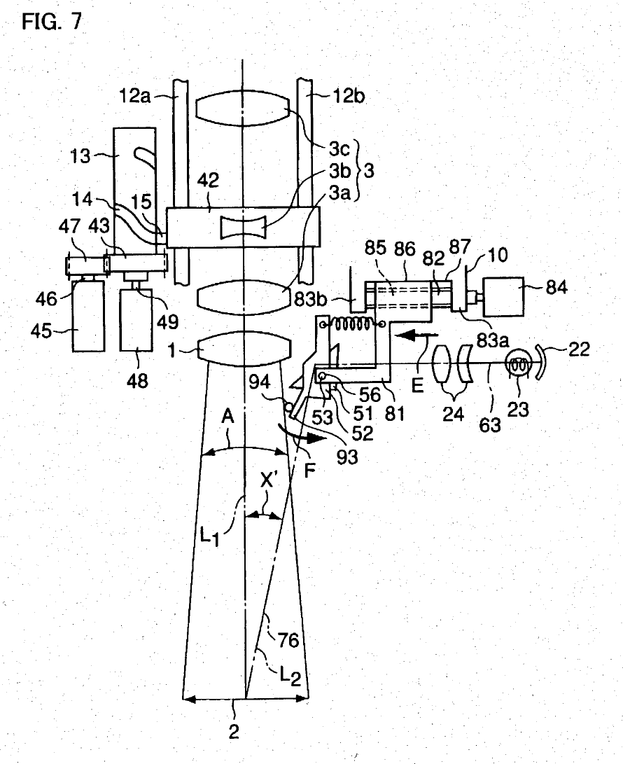

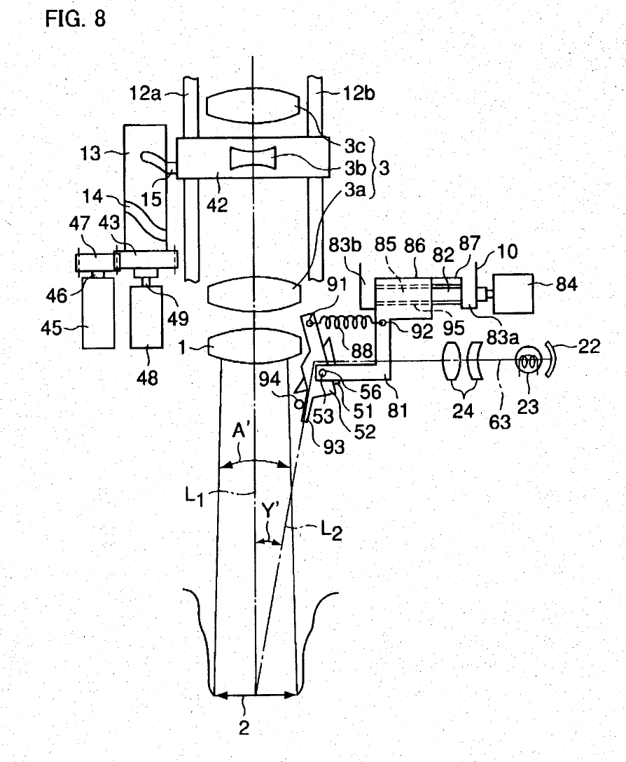

An operating microscope according to a third embodiment of the invention will be described below with reference to FIGS. 7 and 8. FIG. 7 is an explanatory view of the operating microscope viewed from one side thereof, which is set to the state of enabling an area of an observation target to be observed at low magnification. FIG. 8 is an explanatory view of the operating microscope viewed from the one side thereof, which is set to the state of enabling an area of an observation target to be observed at high magnification. In the description of the third embodiment as well, constituent parts and portions common to those of the first and second embodiments are denoted by the same reference numerals, and the description of the same parts and portions is omitted.

In the operating microscope according to the third embodiment, the fitting hole 56 for supporting the rotating shaft 53 of the prism frame 52 which supports the reflecting member 51 is provided in a moving member 81. The moving member 81 is supported by a horizontally arranged ball thread 82. The opposite ends of the ball thread 82 are respectively supported by bearing portion 83a and 83b provided in the lens barrel housing 10. The ball thread 82 is parallel to the illuminating optical axis 63 of the illuminating optical system.

An output shaft of a motor 84 is connected to one end of the ball thread 82, and the angle of rotation of the motor 84 is controlled on the basis of information from the encoder 48. The moving member 81 has a plane portion 86 and a threaded hole 85 which is screwed on the ball thread 82. The plane portion 86 is in surface contact with a guide plane portion 87 provided in the lens barrel housing 10, whereby the rotation of the moving member 81 itself is prevented. The plane portions 86 and 87 are parallel to the axis of the ball thread 82, and do not at all hinder the movement of the moving member 81. The moving member 81 is only moved back and forth in directions parallel to the illuminating optical axis 63 of the illuminating optical system by the ball thread 82 being rotated by the motor 84, and since the plane portion 86 and the guide plane portion 87 are in contact with each other, the moving member 81 does not rotate with respect to the ball thread 82.

As shown in FIGS. 7 and 8, a tension spring 88 is passed between the moving member 81 and one end of the prism frame 52 which supports the reflecting member 51. The one end of the prism frame 52 and the moving member 81 respectively have spring hooking portions 91 and 92 on which the tension spring 88 is hooked. One end of the tension spring 88 is hooked on the spring hooking portion 91 of the prism frame 52, and the other end of the tension spring 88 is hooked on the spring hooking portion 92 of the moving member 81. Accordingly, the prism frame 52 is pulled toward the moving member 81 and is urged to turn in the direction indicated by an arrow F in FIG. 7.

A restricting portion 93 is formed in such a manner as to be integral with and protruded from the other bottom end of the prism frame 52. The restricting portion 93 is in contact with a positioning pin 94 provided in the lens barrel housing 41, and the restricting portion 93 is constantly held in abutment with the positioning pin 94 by the urging action of the tension spring 88. The rotation angle through which the prism frame 52 can rotate about the rotating shaft 53 is restricted by the action of the abutment of the restricting portion 93 with the positioning pin 94. The position of the positioning pin 94 is set at a particular location where the position of the restricting portion 93 is restricted so that illuminating light flux exiting from the reflecting member 51 can be constantly positioned to aim toward the observation target 2 no matter where the moving member 81 may be moved by the rotation of the ball thread 82. The illuminating optical system is disposed in the space between the objective lens 1 and the observation target 2 and can irradiate illuminating light onto the observation target 2.

The function of the illuminating light irradiation angle varying mechanism of the third embodiment will be described below. When the motor 84 is rotated on the basis of information from the encoder 48, the ball thread 82 which is fixed to the output shaft of the motor 84 is rotated by the same angle as the motor 84. As the ball thread 82 is rotated, the moving member 81 having a threaded portion 95 screwed on the ball thread 82 is moved in the direction of the arrow E shown in FIG. 7 in parallel with the illuminating optical axis 63.

When the moving member 81 is moved in this manner, the prism frame 52 supported by the moving member 81 tends to move together, but since the restricting portion 93 is in abutment with the positioning pin 94, the prism frame 52 makes a rotation about the rotating shaft 53 in the direction of the arrow F at the same time when the prism frame 52 is moved. Thus, the operating microscope is varied from the state of low-magnification observation shown in FIG. 7 to the state of high-magnification observation shown in FIG. 8.

As described above, according to the illuminating light irradiation angle varying mechanism of the third embodiment, the observing optical axis L1 becomes closer to the illuminating optical axis L2 in interlocking relationship to the manipulation of the operator 40 to vary observing magnification from lower magnification to higher magnification, similarly to the case of each of the first and second embodiments. Accordingly, even when the operator 40 is to observe the interior of a deep hole which often needs to be observed at high magnification, the area of the observation target 2 may be irradiated with a sufficient amount of illuminating light, so that the area of the observation target 2 may be observed in a brightly illuminated state. In addition, during observation at low magnification, the members of the illuminating optical system do not at all interfere with the passage of an observing light flux nor hinder observation. Furthermore, the illuminating light flux is directed to the observation target 2 by the reflecting member 51 disposed below the objective lens 1 and does not pass through the objective lens 1. Accordingly, an adverse influence such as flare on the observing optical system due to the surface reflection of the objective lens 1 does not occur. In addition, since the number of motors for moving the illuminating optical system is one, the illuminating light irradiation angle varying mechanism can be inexpensively constructed.

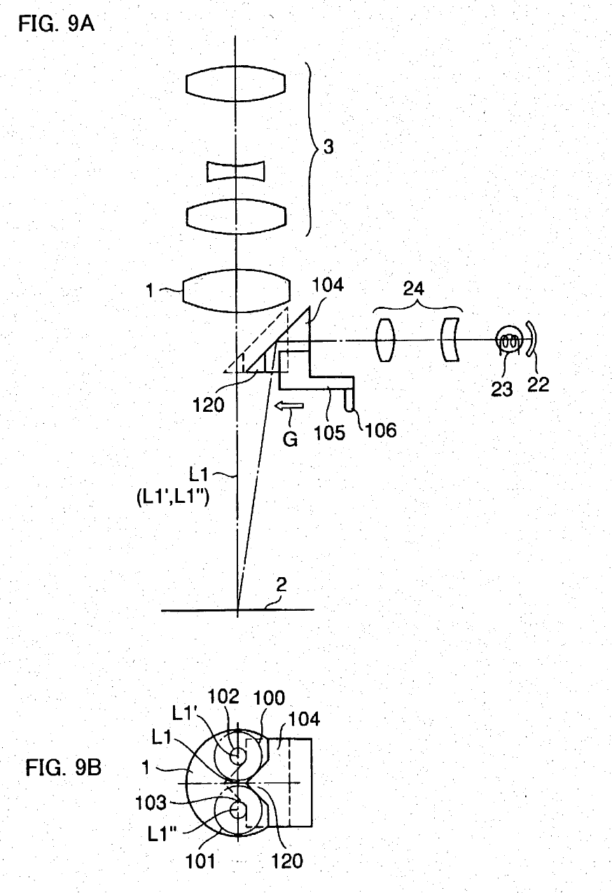

An operating microscope according to a fourth embodiment of the invention will be described below with reference to FIGS. 9A and 9B. FIG. 9A is a view of the operating microscope viewed from one side thereof, while FIG. 9B is a view of the operating microscope viewed from below. In the description of the fourth embodiment, constituent parts and portions common to those of the first to third embodiments are denoted by the same reference numerals, and the description of the same parts and portions is omitted. The following description focuses on the illuminating optical system disposed in the space between the objective lens 1 and the observation target 2 and constructed to irradiate illuminating light onto the observation target 2.

In FIGS. 9A and 9B, L1′ and L1″ respectively denote the central axes of the left and right observing light fluxes having a parallax for enabling a stereoscopic view. In FIG. 9B, reference numerals 100 and 101 respectively denote the diameters of the observing light fluxes L1′ and L1″ for low-magnification observation. In FIG. 9B, reference numerals 102 and 103 respectively denote the diameters of the observing light fluxes L1′ and L1″ for high-magnification observation.

In FIGS. 9A and 9B, reference numeral 104 denotes a reflecting member for bending the advancing direction of light emitted from the illuminating light source 23 of illuminating means, toward the observation target 2. The reflecting member 104 is fixedly held on a prism frame 105 by an adhesive or the like. The prism frame 105 is supported by a horizontal movement mechanism such as a guide shaft which is not shown, and constitutes a part of a varying mechanism which is movable back and forth in horizontal directions perpendicular to the observing optical axis L1. A lever 106 is formed in a portion such as the rear end of the prism frame 105. The lever 106 is protruded to the outside of a microscope body which is not shown, and the lever 106 can be used to manually move the prism frame 105. In addition, the observing optical system is controlled to be set for either of high-magnification observation and low-magnification observation in interlocking relationship to the manipulation of the lever 106.

As shown in FIG. 9B, a protruding portion 120 which is protruded toward the middle position between the left and right observing light fluxes L1′ and L1″ is formed to integrally extend from the reflecting member 104. The protruding portion 120 also serves a part of the function of a reflecting member which constitutes a part of the illuminating optical system. The protruding portion 120 has a shape which protrudes into the central position between the left and right observing light fluxes L1′ and L1″ and becomes narrower in width toward the protruding end. In FIG. 9B, the protruding portion 120 is shown to have a triangular shape, by way of example. Thus, the protruding portion 120 constitutes an optical element capable of being inserted between the two observing light fluxes L1′ and L1″.

In the case where an observer observes the observation target 2 at low magnification, the reflecting member 104 is arranged at the position shown by solid lines in FIGS. 9A and 9B. The left and right observing light fluxes L1′ and L1″ for forming a stereoscopic view are larger (longer in diameter) than those for high-magnification observation, but since the reflecting member 104 is positioned at a position set back from the observing optical axis L1, the reflecting member 104 does not at all interfere with the left and right observing light fluxes L1′ and L1″.

In the case where the observer desires to control the variable magnification lens system 3 in order to observe the observation target 2 at high magnification, the observer moves the lever 106 in the direction of an arrow G in FIG. 9A, whereby the position of the reflecting member 104 is varied to the position shown by dashed lines in FIGS. 9A and 9B and the reflecting member 104 approaches the observing light fluxes L1′ and L1″ up to a position where the reflecting member 104 does not interfere with the observing light fluxes L1′ and L1″. However, the left and right observing light fluxes L1′ and L1″ for forming a stereoscopic view for high-magnification observation are smaller (shorter in diameter) than those for low-magnification observation, so that the reflecting member 104 can be made closer to the observing light fluxes L1′ and L1″ during high-magnification observation than during low-magnification observation.

As described above, according to the fourth embodiment, a part of the reflecting member 104 of the illuminating optical system that is close to the objective lens 1 is formed in an effective shape which can be inserted between the two observing light fluxes L1′ and L1″ to avoid the two observing light fluxes L1′ and L1″. Accordingly, in the case where the operator changes observing magnification from lower magnification to higher magnification, the position of the illuminating light flux can be made closer to the observing light fluxes L1′ and L1″ by a varying mechanism. Accordingly, when the operator is to observe the interior of a deep hole which often needs to be observed at high magnification, the area of the observation target 2 can be irradiated with a sufficient amount of illuminating light, so that the operator can observe the area of the observation target 2. In addition, even during observation at low magnification, the members of the illuminating optical system do not at all interfere with the passage of the observing light fluxes L1′ and L1″.

In addition, the protruding portion 120 of the reflecting member 104 is inserted between the left and right observing light fluxes L1′ and L1″ within the range where the protruding portion 120 does not interfere with either of the left and right observing light fluxes L1′ and L1″. Accordingly, the protruding portion 120 can be positioned in an area not occupied by the observing light fluxes L1′ and L1″, whereby the dead space between the observing light fluxes L1′ and L1″ can be effectively used to increase the efficiency of reflection (since illuminating light is made incident on the observation target 2 at an angle far closer to perpendicularity, the efficiency of reflection at the observation target 2 is high) At the same time, the center of the illuminating light flux can be made closer to the observing light fluxes L1′ and L1″ compared to the case where the protruding portion 120 is absent.

Similarly to the case of each of the above-described embodiments, the illuminating optical axis is made closer to the observing optical axis L1 in interlocking relationship to the manipulation of varying observing magnification from lower magnification to higher magnification. Accordingly, even when the operator is to observe the interior of a deep hole which often needs to be observed at high magnification, the area of the observation target 2 may be easily irradiated with illuminating light. In addition, even during observation at low magnification, the members of the illuminating optical system do not at all interfere with an observing light flux nor hinder observation.

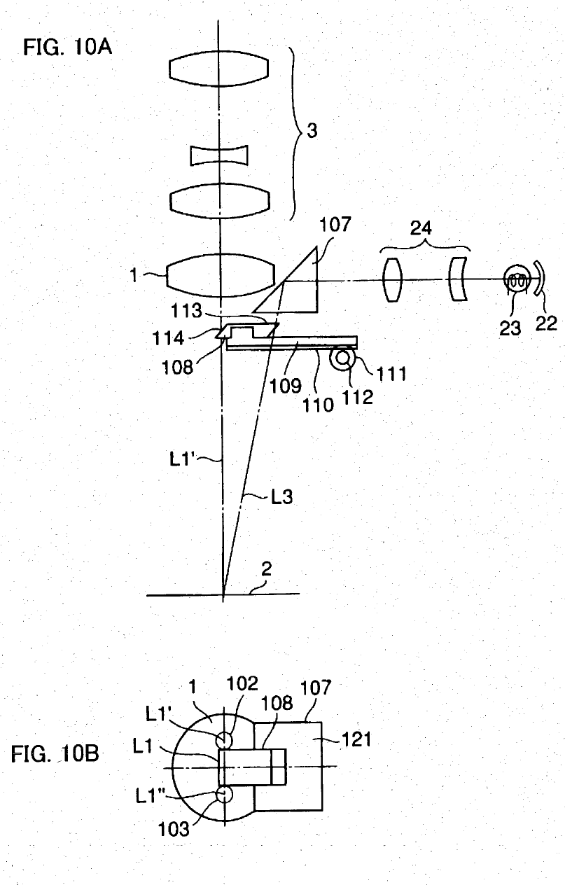

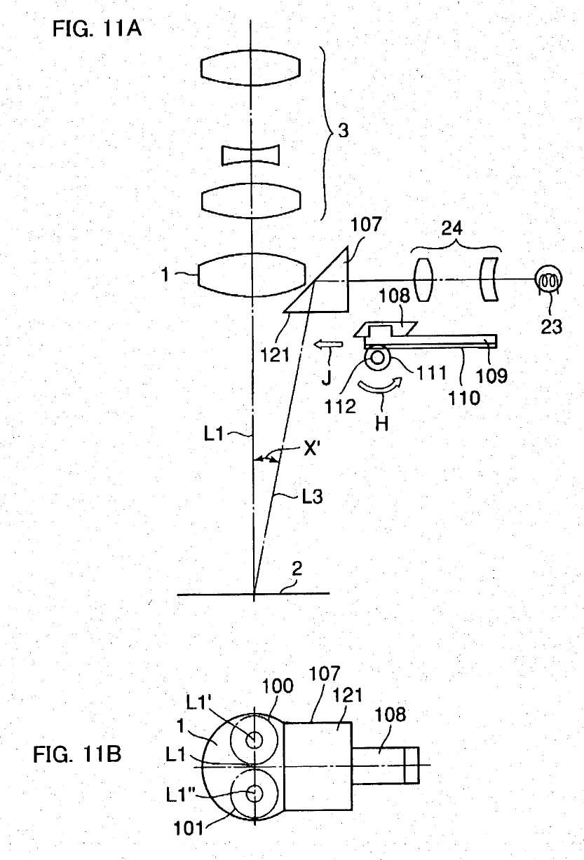

An operating microscope according to a fifth embodiment of the invention will be described below with reference to FIGS. 10A, 10B, 11A, and 11B. FIG. 10A is a schematic view of the operating microscope viewed from one side thereof, through which the observation target 2 is observed at low magnification, while FIG. 10B is a schematic view of the operating microscope viewed from below. FIG. 11A is a schematic view of the operating microscope viewed from one side thereof, through which the observation target 2 is observed at high magnification, while FIG. 11B is a schematic view of the operating microscope viewed from below. In the description of the fifth embodiment, constituent parts and portions common to those of the first to fourth embodiments are denoted by the same reference numerals, and the description of the same parts and portions is omitted. The following description focuses on the illuminating optical system disposed in the space between the objective lens 1 and the observation target 2 at least in part, and constructed to irradiate illuminating light onto the observation target 2.

In FIGS. 10A and 11A, reference numeral 107 denotes a reflecting member (for example, a prism) for bending light emitted from the illuminating light source 23 of illuminating means, toward the observation target 2. The reflecting member 107 is fixedly disposed close to the diameters 100 and 101 of the observing light fluxes L1′ and L1″ for low-magnification observation. Symbol L3 denotes the optical axis of a light flux exiting from the reflecting member 107 toward the observation target 2.

A prism 108 having a parallelogramatic external shape in side view is disposed below the reflecting member 107. The parallelogramatic prism 108 is held on a prism frame 109 by adhesion or the like. The prism frame 109 is movable back and forth in horizontal directions perpendicular to the observing optical axis L1, and theses movements are realized through a varying mechanism which will be described later.

As shown in FIG. 10B, the width between the right and left sides of the parallelogramatic prism 108 is selected to be a size which enables the parallelogramatic prism 108 to be inserted between the observing light fluxes L1′ and L1″ for high-magnification observation without interfering with the observing light fluxes L1′ and L1″. Thus, the parallelogramatic prism 108 constitutes an optical element of the illuminating optical system which can be inserted between the two observing light fluxes L1′ and L1″.

A rack 110 is formed on the bottom surface of the prism frame 109. A pinion 111, which is engaged with the rack 110, is disposed under the prism frame 109. A rotating shaft 112 of the pinion 111 is rotatably supported on a microscope body (not shown). The rotating shaft 112 is protruded to the outside of the microscope body, and a rotationally manipulating knob (not shown) is fixed to the protruding end of the rotating shaft 112 for manipulation by a user.

The function of the fourth embodiment will be described below. In the case where an observer observes the observation target 2 at low magnification, the parallelogramatic prism 108 is arranged at the position shown in FIGS. 11A and 11B, i.e., at a position where the parallelogramatic prism 108 does not overlap an exit surface 121 of the reflecting member 107. Accordingly, light emitted from the illuminating light source 23 is not made incident on the parallelogramatic prism 108, so that the observing optical axis L1 and the illuminating optical axis L3 forms the angle X′.

In the case where the observer controls the variable magnification lens system 3 and observes the observation target 2 at high magnification, the observer rotates the manipulating knob (not shown) in the direction of an arrow H in FIG. 11A. Since the pinion 111 is rotated by the rotation applied to the manipulating knob, the prism frame 109 provided with the rack 110 engaged with the pinion 111 is moved in the direction of an arrow J in FIG. 11A. Accordingly, the parallelogramatic prism 108 enters an area under the objective lens 1, and is brought into the state shown in FIGS. 10A and 10B. Namely, an incident surface 113 of the parallelogramatic prism 108 is positioned under the reflecting member 107, and a second reflecting surface 114 formed at one end of the parallelogramatic prism 108 is arranged on the observing optical axis L1.

When the observer observes the observation target 2 at high magnification, the diameters 102 and 103 of the observing light fluxes L1′ and L1″ are smaller than the diameters 100 and 101 of the observing light fluxes L1′ and L1″ for low-magnification observation, so that the parallelogramatic prism 108 can be arranged between the observing light fluxes L1′ and L1″ without interfering with the observing light fluxes L1′ and L1″. Accordingly, part of the illuminating light flux exiting from the reflecting member 107 enters the parallelogramatic prism 108, and the entering light flux is reflected twice in the parallelogramatic prism 108 and then exits from the parallelogramatic prism 108 toward the observation target 2 as a light flux having the same axis as the observing optical axis L1. Thus, a portion of the light flux from the illuminating light source 23 is directed on optical axis L3 and a portion is directed on optical axis L1.

As described above, according to the fifth embodiment, in the case where the operator changes observing magnification from lower magnification to higher magnification, the position of the illuminating light flux can be made closer to the observing light fluxes L1′ and L1″. Accordingly, when the operator is to observe the interior of a deep hole which often needs to be observed at high magnification, the operator may observe the area of the observation target 2 illuminated with a sufficient amount of illuminating light. In addition, even during observation at low magnification, the members of the illuminating optical system do not at all interfere with the passage of the observing light fluxes L1′ and L1″. Particularly in the fifth embodiment, in the case of observation at high magnification, illuminating light may be directed to the observation target 2 through the space between a pair of left and right optical systems which constitute the observing optical system, whereby the effect of illumination on the interior of a deep hole to be observed is remarkably improved.

Although the motors are described for changing from a low magnification to a high magnification configuration in these embodiments, of course, the motors can also operate in a reverse direction to go from the high magnification configuration back towards the low magnification configuration.

Furthermore, the microscopes of the several embodiments are described as having low and high magnification configurations and means for varying both the illuminating optical system and the magnification optical system accordingly. Of course, such systems can also be varied for configurations any where between such high and low magnification configurations.

As is apparent from the foregoing description, according to the invention, illuminating light may be easily made to reach an area to be operated on, even a deep and thin hole which often needs to be observed at high magnification, and during observation at low magnification, the illuminating optical system does not at all interfere with the passage of an observing light flux. Accordingly, the operator can consistently perform an operation with a bright field of view ensured.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An operating microscope comprising:
an observing optical system for observing an observation target, the observing optical system having observing magnification capable of being varied; and
an illuminating optical system for irradiating illuminating light onto the observation target from a position outside the observing optical system, an exit position of the illuminating light of the illuminating optical system being capable of being varied such that the illuminating light is at least partially incident on the observation target regardless of a variation in the observing magnification.

2. An operating microscope according to claim 1 further comprising a system for correlating a variation of the observing magnification of the observing optical system with a corresponding variation of the exit position of the illuminating light of the illuminating optical system.

3. An operating microscope according to claim 2, wherein the system correlates a variation to higher magnification in the observing magnification of the observing optical system with a corresponding variation of the exit position of the illuminating light of the illuminating optical system toward a position closer to an optical axis of the observing optical system.

4. An operating microscope according to claim 2, wherein the system correlates a variation to lower magnification in the observing magnification of the observing optical system with a corresponding variation of the exit position of the illuminating light of the illuminating optical system toward a position more distant from an optical axis of the observing optical system.

5. An operating microscope according to claim 2, wherein the system controls the exit position of the illuminating light of the illuminating optical system to make the exit position closer to the optical axis of the observing optical system when the observing optical system is set for higher magnification than when the observing optical system is set for lower magnification.

6. An operating microscope according to claim 2, wherein the system controls the exit position of the illuminating light according to a variation in cross section of an observing light flux, which variation accompanies a variation of the observing magnification of the observing optical system, so that an optical body of the illuminating optical system does not interfere with the observing light flux.

7. An operating microscope according to claim 1, wherein a variation of the exit position of the illuminating light of the illuminating optical system is also accompanied by a variation of an exiting direction of the illuminating light.

8. An operating microscope according to claim 7, wherein a variation of the exit position of the illuminating light of the illuminating optical system toward a position closer to an optical axis of the observing optical system is accompanied by a variation of the exiting direction of the illuminating light toward a direction in which an angle formed by the exiting direction and the optical axis of the observing optical system becomes smaller.

9. An operating microscope according to claim 7, wherein a variation of the exit position of the illuminating light of the illuminating optical system toward a position more distant from an optical axis of the observing optical system is accompanied by a variation of the exiting direction of the illuminating light toward a direction in which an angle formed by the exiting direction and the optical axis of the observing optical system becomes larger.

10. An operating microscope according to claim 7, wherein an optical axis of the illuminating optical system passes through the observation target during the variations of the exit position and the exiting direction of the illuminating light of the illuminating optical system.

11. An operating microscope according to claim 10, wherein the illuminating optical system varies the exit position and the exiting direction of the illuminating light by moving along a circular-arc-shaped locus centered at the observation target.

12. An operating microscope according to claim 7, further comprising:
a turnable reflecting member for reflecting illuminating light from an illuminating light source; and
a movement mechanism for moving a position of the reflecting member to vary a distance between the reflecting member and an optical Axis of the observing optical system, wherein the exist position and the exiting direction of the illuminating light of the illuminating optical system being varied by a rotation and translation movement of the reflecting member.

13. An operating microscope according to claim 12, wherein the movement mechanism includes a rack operatively connected to one of the reflecting member and a body of the microscope and a pinion mechanism operatively connected to the other of the reflecting member and the body, wherein the rack and pinion are meshingly engaged.

14. An operating microscope according to claim 12, wherein the rotation and translation movement of the reflecting member are driven by a motor.

15. An operating microscope according to claim 1, wherein the observing optical system has a pair of right and left observing optical paths for stereoscopic view, and
wherein a variation range in which the exit position of the illuminating light may vary includes a space between a light flux passing through the right observing optical path and a light flux passing through the left observing optical path.

16. An operating microscope according to claim 15, wherein an outer shape of the container of the illuminating optical system is narrower in width at a distal end than at a proximal end in a vicinity of the exit position of the illuminating light.

17. An operating microscope according to claim 1, wherein a variation range of the exit position of the illuminating light is included in a space between an objective lens of the observing optical system and the observation target.

18. An operating microscope according to claim 1, wherein a variation of the exit position of the illuminating light is realized by an optical-path varying member being inserted into and retracted from an illuminating optical path.

19. An operating microscope according to claim 1, wherein the observing optical system includes:
an objective lens causing a light flux incident thereon to exit as an afocal light flux;
a variable magnification optical system performing afocal magnification variation on the light flux incident from the objective lens and causing the light flux to exit as an afocal light flux; and
an ocular optical system having an image-forming lens for forming an image of the afocal light flux incident from the variable magnification optical system, and an ocular lens for magnifying the image formed by the image-forming lens.

20. An operating microscope comprising:
an objective lens on which a light flux from an observation target is made incident;
a variable magnification lens system on which a light flux from the objective lens is made incident and which varies an observing magnification of the observation target;
an observing part for observing an optical image formed on the basis of a light flux from the variable magnification lens system;
an illuminating optical system disposed in a space between the objective lens and the observation target and capable of irradiating illuminating light onto the observation target; and
a varying mechanism for varying a relative position between at least a part of the illuminating optical system and an optical axis of the objective lens.

21. An operating microscope comprising:
an objective lens on which a light flux from an observation target is made incident;
a variable magnification lens system on which a light flux from the objective lens is made incident and which varies an observing magnification of the observation target;
an observing part for observing an optical image formed on the basis of a light flux from the variable magnification lens system;
an illuminating optical system at least partially disposed in a space between the objective lens and the observation target and capable of irradiating illuminating light onto the observation target; and
a varying mechanism for varying at least one of an exit position and exit direction of the illuminating light from the illuminating optical system such that the illuminating light is at least partially incident on the observation target regardless of a variation in the observing magnification.

22. An operating microscope comprising:
an observing optical system for observing an observation target, the observing optical system having observing magnification capable of being varied;
an illuminating optical system for irradiating illuminating light onto the observation target from a position outside the observing optical system, an exit position of the illuminating light being capable of being varied; and
a system for correlating a variation of the observing magnification of the observing optical system with a corresponding variation of the exit position of the illuminating light of the illuminating optical system.

23. A method of irradiating illuminating light in an operating microscope, the method comprising:
irradiating illuminating light onto an observation target when a variable magnification observing optical system is set for one of a high magnification and low magnification;
varying the variable magnification observing optical system to another of the high magnification and low magnification observation; and
changing at least one of a exit position and exit direction of the illuminating light such that the illuminating light remains incident on the observation target regardless of the variation in the magnification observing optical system.

24. The method of claim 23, wherein the illuminating light is irradiated onto an observation target from a position closer to an observing optical axis when the variable magnification observing optical system is set for high magnification than when the variable magnification observing optical system is set for low-magnification observation.

25. A method of claim 23, wherein the illuminating light is irradiated onto the observation target through a space between right and left observing light fluxes when the variable magnification observing optical system is set for high magnification, while when the variable magnification observing optical system is set for low magnification, illuminating light is irradiated onto the observation target from a location outside of the right and left observing light fluxes and except the space between the right and left observing light fluxes.
